(19) United States
(12) Patent Application Publication
(10) Pub. No.: US 2025/0371219 A1
(43) Pub. Date: Dec. 4, 2025

(54) ERROR RECOVERY OF FINE RESOLUTION ON ADAPTIVE FINITE ELEMENT ANALYSIS MESHES FOR SIMULATION OF ADDITIVE MANUFACTURING

(71) Applicant: PANOPTIMIZATION, LLC, State College, PA (US)

(72) Inventor: Panagiotis MICHALERIS, State College, PA (US)

(73) Assignee: PANOPTIMIZATION, LLC, State College, PA (US)

(21) Appl. No.: 18/920,444

(22) Filed: Oct. 18, 2024

Related U.S. Application Data
(60) Provisional application No. 63/654,851, filed on May 31, 2024.

(51) Int. Cl. G06F 30/23; G06F 113/10

(52) U.S. Cl. CPC G06F 30/23; G06F 2113/10

(57) ABSTRACT

A method of simulating additive manufacturing, including determining a first displacement field on a first adaptive finite element mesh of an object; determining a second adaptive finite element mesh by adding an additional element group to the first adaptive finite element mesh, and when coarsening criteria is met, generating at least one coarse element by coarsening two or more elements of the first adaptive finite element mesh; calculating, from the first displacement field, a second displacement field on the determined second adaptive finite element mesh; determining an error between the first and second displacement fields; calculating a displacement field change on the determined second adaptive finite element mesh using a finite-element analysis model; and calculating a fine displacement field on a fine finite element mesh by adding together the second displacement field, the determined error, and the calculated displacement field change.

### CROSS-REFERENCE TO RELATED APPLICATIONS

The present application claims priority to U.S. Provisional Application No. 63/654,851, filed May 31, 2024, which is incorporated herein by reference in its entirety for all purposes.

### TECHNICAL FIELD

The present disclosure relates to simulation and optimization of additive manufacturing builds.

### BACKGROUND

Additive manufacturing (AM) and welding of parts frequently result in residual stress-induced failures (e.g., loss of dimensional accuracy, cracking, and printer jams) due to the plastic deformation, metallurgical transformations, and thermal cycles that are inherent to the process. Finite element models are commonly used to simulate and predict these thermomechanical issues prior to manufacturing. Simulation runtimes and memory consumption increase cubically as model size increases, meaning that parts become increasingly difficult to simulate as they become larger and/or more complex.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

In one embodiment, the present disclosure is related to a method of simulating additive manufacturing, the method comprising: determining a first displacement field on a first adaptive finite element mesh of an object; determining a second adaptive finite element mesh by adding an additional element group to the first adaptive finite element mesh, and when coarsening criteria is met, generating at least one coarse element by coarsening two or more elements of the first adaptive finite element mesh; calculating, from the first displacement field, a second displacement field on the determined second adaptive finite element mesh; determining an error between the first and second displacement fields; calculating a displacement field change on the determined second adaptive finite element mesh using a finite-element analysis model; and calculating a fine displacement field on a fine finite element mesh by adding together the second displacement field, the determined error, and the calculated displacement field change.

In one embodiment, the present disclosure is related to an apparatus for simulating additive manufacturing, comprising processing circuitry configured to determine a first displacement field on a first adaptive finite element mesh of an object, determine a second adaptive finite element mesh by adding an additional element group to the first adaptive finite element mesh, and when coarsening criteria is met, generating at least one coarse element by coarsening two or more elements of the first adaptive finite element mesh, calculate, from the first displacement field, a second displacement field on the determined second adaptive finite element mesh, determine an error between the first and second displacement fields, calculate a displacement field change on the determined second adaptive finite element mesh using a finite-element analysis model, and calculate a fine displacement field on a fine finite element mesh by adding together the second displacement field, the determined error, and the calculated displacement field change.

In one embodiment, the present disclosure is related to a non-transitory computer-readable storage medium for storing computer readable instructions that, when executed by a computer, cause the computer to perform a method, the method comprising determining a first displacement field on a first adaptive finite element mesh of an object; determining a second adaptive finite element mesh by adding an additional element group to the first adaptive finite element mesh, and when coarsening criteria is met, generating at least one coarse element by coarsening two or more elements of the first adaptive finite element mesh; calculating, from the first displacement field, a second displacement field on the determined second adaptive finite element mesh; determining an error between the first and second displacement fields; calculating a displacement field change on the determined second adaptive finite element mesh using a finite-element analysis model; and calculating a fine displacement field on a fine finite element mesh by adding together the second displacement field, the determined error, and the calculated displacement field change.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is an adaptive mesh according to one embodiment of the present disclosure;

FIG. 1B is an adaptive mesh according to one embodiment of the present disclosure;

FIG. 2A is a displacement field according to one embodiment of the present disclosure;

FIG. 2B is an illustration of displacement field error according to one embodiment of the present disclosure;

FIG. 2C is a fine displacement field according to one embodiment of the present disclosure;

FIG. 3 is a flowchart of an adaptive mesh coarsening method according to one embodiment;

FIG. 4 is a model of an object according to one embodiment;

FIG. 5 illustrates mechanical simulation of finite element meshes according to one embodiment; and

FIG. 6 is a schematic of a hardware system for performing a method according to one embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

In one embodiment, the present disclosure is directed to mesh homogenization for finite element analysis. Three-dimensional (3D) modeling can be used to characterize objects that are fabricated through additive manufacturing methods. The modeling can include determining characteristics of an object and simulating a layered (additive) build process. Additive manufacturing processes can include, but are not limited to, 3D printing, laser powder bed fusion (L-PBF), direct metal laser sintering (DMLS), and selective laser melting (SLM), and other metal or nonmetal processes. The additive manufacturing process can result in the formation of microstructures in an object. The placement of the microstructures can depend on the geometry of the object and variation in cooling of the object's layers as they are formed. The microstructures can affect the mechanical properties of a fabricated objects. Additive manufacturing processes also result in formation of residual stress and a specific thermomechanical response in the deposited material. The residual stress can impact the geometric tolerance of an object.

Simulation of a build process can be used to identify where microstructures will form in an object and characterize the mechanical properties of the object when it is fabricated in an additive manufacturing process. Simulation of the build process can also be used to characterize residual stress and distortion resulting from the additive manufacturing process. Said simulation can be based on a three-dimensional mesh of the object.

In one embodiment, thermomechanical simulation and analysis of the build process of an object can be used to determine material properties, temperature history, distortion, and residual stress state of the object. Simulation of the build process can include simulating additions of each layer of a three-dimensional mesh representing the object. For example, in L-PBF, the object is manufactured by melting and fusing material in a powder form using a laser beam (or electron beam). The laser beam melts the powder in a specific pattern, and each layer of melted powder in the pattern fuses with the existing fused layers to add to the object in a build direction (e.g., vertically). L-PBF can use very small lasers to achieve thin or finely detailed objects with very high material density. Simulation of the build process can include analysis of the object's thermal and mechanical response and/or material properties as each layer is added. The simulation can include a temporal component to model how quickly a layer is fabricated and the temperature and distortion of materials change over time as a layer forms and cools. The object can be a heterogeneous material, e.g., a composite material.

An accurate simulation can reduce the need for repeated physical testing of fabricated objects, which can be expensive and destructive. A simulation also provides a more comprehensive analysis of an object at greater resolution than physical testing, which often only focuses on and identifies select points of failure. In one embodiment, the processes described herein can be used to determine mechanical, diffusive, thermal, or electrical properties and thermomechanical responses of an object via finite element analysis, as well as failure points resulting from the material properties and thermomechanical response. These properties can be anisotropic and can be tensor-valued, e.g., stress tensor, strain tensor, elasticity tensor. Directional heat flow during additive manufacturing can result in a significant thermal gradient, which can cause deformation and stress and introduce variation in material properties throughout an object.

Different material properties can be determined via simulation at different scales. For example, microstructure evolution and fluid dynamics of molten pools can be determined at micron-level scale; however, this analysis cannot be scaled effectively for most manufactured objects. As the scale increases, different modeling assumptions can be implemented to simplify or generalize certain material dynamics, such as the effect of a heat source (e.g., high energy laser beam). The analysis can include modeling materials (e.g., a metal) at different states (e.g., powder, solid, liquid), wherein the materials can have temperature-dependent properties in each state. In one embodiment, the analysis can include effects of material solidification and evaporation, which can cause layer shrinkage. In one embodiment, the analysis can be based on microstructure formation in the materials. For example, a heterogeneous material can have periodic microstructures. The distribution of the microstructures can affect the formation and homogenization of the object mesh. In one embodiment, the simulation can include modeling the actual material(s) of the object as one or more different materials. For example, the simulation can include modeling a heterogeneous region as a representative homogeneous region (e.g., asymptotic homogenization) when the difference in properties between the materials of the two regions is taken into account in the modeling.

In one embodiment, analysis of a mesh when a new layer is added in a simulation can include not only analysis of the new layer but also analysis of the mesh as a whole as a result of the addition of the new layer. When the additive manufacturing simulation is complete, the determined material properties and thermomechanical response can be used to model and assess the temperature, distortion, and stress and strain profile of the object, as well as derivative properties of the object such as elasticity (Young's modulus), Poisson ratio, shear modulus, yield strength, tensile strength, and fatigue.

Determination of the properties can be complex and can require a large amount of processing power to model the addition of each layer in the build, especially for objects with complex or large geometries. These objects can have nodes on the order of millions to billions. Therefore, it can be beneficial to reduce the complexity of a three-dimensional mesh while preserving resolution of fine geometric details and features in the mesh for accurate modeling.

In one embodiment, finite element analysis (FEA) (also referred to as the finite element method (FEM)) can be applied to a discretized three-dimensional mesh of an object to determine thermomechanical response and material properties of the object. The mesh can be composed of elements (e.g., voxels) of any shape that can form a mesh, including, but not limited to, cubes, hexahedron cells, tetrahedron cells, etc. The mesh can be referred to as a finite element mesh or voxel mesh. In one embodiment, FEA can be applied to solve a number of equations (e.g., boundary conditions) describing material behaviors or properties in an object. In one embodiment, the material behaviors or properties can be determined based on the additive manufacturing process (e.g., the rate of layer formation) and/or material phase, which can be time-dependent. In one embodiment, the boundary conditions can describe a deformation gradient, stress, strain, etc.

The coarseness (e.g., size of elements) of meshes used in FEA can affect the efficiency and accuracy of a simulation. For example, analysis of large voxels can be faster but may result in inaccurate assessment due to the high level of generalization and omission of fine features, while analysis of smaller voxels may result in more accurate characterization of variations in material properties but can require more computation time and power. The accuracy of FEA using a voxel of a certain size can also depend on where the voxel is located within the mesh of the object as a whole. The structure and geometry of the object itself can affect the degree of homogenization and element size that is appropriate for accurate analysis.

In one embodiment, the present disclosure is directed to systems and methods for error recovery in adaptive meshing. Adaptive meshing (or adaptive mesh coarsening) can include generating or modifying a mesh having a non-uniform density. The density of the mesh can vary across different regions of the mesh. For example, a first region can have a finer mesh with a greater density of elements, while a second region can have a coarser mesh with a lower density of elements. Elements that are coarsened can be combined, merged, extrapolated, or replaced with a representative coarsened element. In practice, it can be useful to deploy a fine mesh in proximity to a (moving) heat source such as an AM laser beam in order to characterize microstructure formation and material properties as the AM laser beam passes through the material.

In one embodiment, adaptive meshing can include modifying the densities of regions of a mesh during the additive manufacturing simulation. For example, a region that has a fine mesh when the AM laser beam is in a certain proximity can be converted to a coarse mesh when the AM laser beam is no longer in the certain proximity. Similarly, a coarse mesh can be converted to a fine mesh based on a pattern and location of the AM laser beam. In one embodiment, an adaptive mesh can be coarsened based on a coarsening criterion. The coarsening criterion can include, for example, a distance of an element or layer of elements from a newly added element or layer of elements. In one embodiment, the coarsening criterion can be based on physical parameters such as a minimum or maximum element size, a material of the object, a geometry of the object, etc.

Adaptive meshing can be more efficient than uniform mesh generation because computational power can be focused on select fine mesh regions. Adaptive meshing can be especially useful for large and complex geometries. However, simulation error can arise in adaptive meshing due to coarsening of the mesh and loss of fine detail in the coarse regions. In some approaches, adaptive mesh coarsening is limited to reduce change in elastic strain energy caused by coarsening. However, limiting adaptive mesh coarsening also limits the benefits associated with adaptive techniques. There is therefore a need for an adaptive FEA meshing approach that does not sacrifice accuracy while also not overly constraining the application of adaptivity. In one embodiment, error recovery can ameliorate the loss of resolution and model accuracy that occurs during adaptive mesh coarsening.

In one embodiment, a method for error recovery can include determining displacement on an adaptive mesh or grid when the mesh is coarsened. The displacement can be a displacement field indicating an element density and/or distribution in an adaptive mesh. The determined displacement field can be used to recover a fine mesh solution which maintains the resolution of the fine mesh. Properties of elements in the fine mesh can be described by fine basis functions. The error recovery can reduce error that results from mesh adaptivity without limiting the mesh adaptivity itself. The determination of error and the error recovery can occur in an iterative adaptive mesh coarsening (or refinement) process. For example, when additive manufacturing is simulated, the mesh can be adaptively coarsened after each element or group of elements is added. A group of elements can be, for example, a layer. In one embodiment, a group of elements can correspond to a region of a layer and can be added to the mesh to simulate fabrication of the layer. The error can be determined at each iteration (or generation) of adding a group of elements to recover a cumulative error.

In one embodiment, the displacement of an adaptive mesh

$${u}_{i}^{A}$$

of a solution grid at a given iteration i can be determined based on the mesh of the previous iteration based on Equation 1:

$${u}_{i}^{A} = {u}_{i - 1}^{A C} + Δ {u}_{i}^{A} \qquad Equation 1$$

where

$${u}_{i - 1}^{AC}$$

is the previous displacement field after coarsening

$$Δ {u}_{i}^{A}$$

and is the change in displacement at the current iteration. The change in displacement can be due to newly added elements and can be calculated using a FEA model. The adaptive mesh can then be In coarsened after the new elements are added to generate the coarsened adaptive mesh

$${u}_{i}^{AC} .$$

In one embodiment, an element can be coarsened when the element meets a coarsening criterion. As an example, an element can be coarsened when it is not part of the most recently added element group (e.g., layer group) and when the element has a neighboring element of the same size.

In one embodiment, the error (E) resulting from adaptive mesh coarsening can be calculated using Equation 2:

$$E = {u}_{i}^{A} - {u}_{i}^{A C} \qquad Equation 2$$

The error can represent a change in the displacement field due to the adaptive mesh coarsening. In one embodiment, the error term E can be used to generate or update a fine (or fine mesh) displacement field. In one embodiment, the fine displacement field

$${u}_{i}^{00}$$

can be computed using Equation 3:

$${u}_{i}^{00} = {u}_{i - 1}^{A C} + Δ {u}_{i}^{A} + E \qquad Equation 3$$

for each iteration. In this manner, a fine mesh can be generated based on the coarsened mesh without actually generating fine mesh elements for the entire object. The method enables simulation of additive manufacturing with the benefits of iterative and adaptive mesh coarsening while also maintaining fine mesh detail of the object.

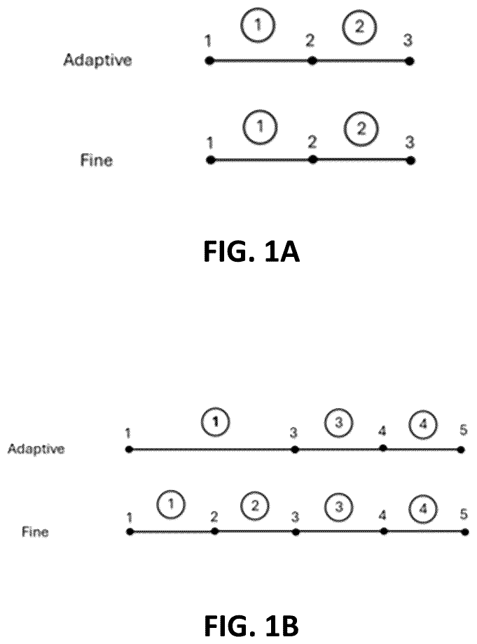

FIG. 1A is an illustration of an adaptive mesh (coarsened mesh) and a fine mesh of a first element group. The element group can include a first element and a second element. Since the first element group is the most recently added element group, the elements are not eligible for coarsening. FIG. 1B is an illustration of the adaptive mesh (coarsened mesh) and the fine mesh after a second element group is added. The second element group can include the third element and the fourth element. In one embodiment, the first and second element of the first element group can be coarsened because they are not the most recently added elements and because they are adjacent and have the same size. As illustrated in FIG. 1B, the coarsened element can be labeled as a first coarsened element and can replace the first and the second element. The first coarsened element can be larger than the first and second elements individually. The center of the first coarsened element (e.g., the midpoint) can be between the centers of the first and the second elements, respectively.

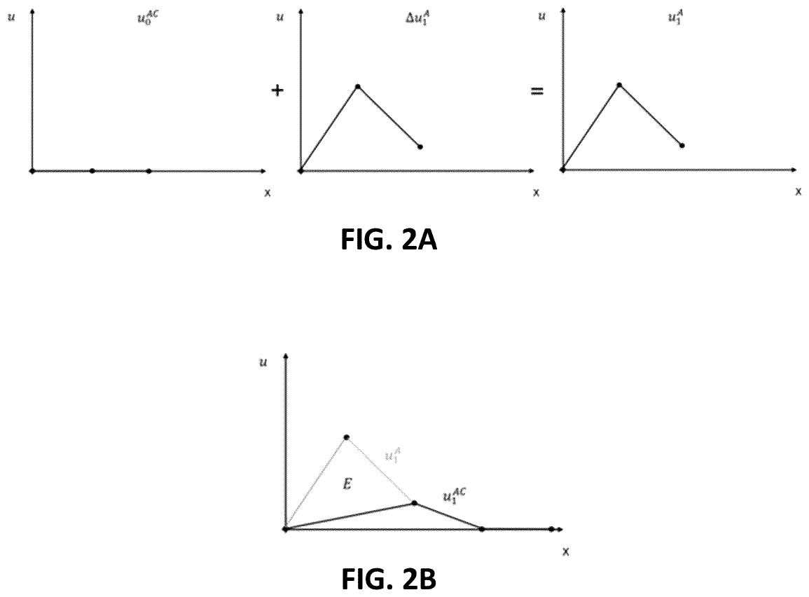

FIG. 2A is an illustration of displacement field calculation for the meshes of FIG. 1A. The displacement field can be calculated using Equation 1. Prior to the addition of the first element group, the initial condition of the displacement field can be

$${u}_{0}^{A} = 0 and {u}_{0}^{A C} = 0 .$$

The change in displacement field

$$Δ {u}_{1}^{A}$$

as a result of the addition of the first element group can include the positions of the first element and the second element along a direction. The displacement field can then be calculated as

$${u}_{1}^{A} = Δ {u}_{1}^{A} .$$

When the second element group including the third element and the fourth element is added to the adaptive mesh, the older elements (first and second elements) can be coarsened because they meet the coarsening criteria. The coarsening of the first and second elements can include combining the first and second elements into a larger first coarsened element, as seen in the adaptive mesh of FIG. 1B. The displacement field

$${u}_{1}^{A C}$$

of the adaptive mesh after coarsening can represent the first coarsened element and the newly added third element and fourth element, which are maintained in fine mesh representation.

FIG. 2B is an illustration of the error E as a result of coarsening

$${u}_{1}^{A} .$$

The displacement field

$${u}_{1}^{AC}$$

replaces the displacement or the first element and the second element with a single displacement from the origin to the third element. The error can be calculated as the difference between

$${u}_{1}^{A C} and {u}_{1}^{A} .$$

The difference can represent the effect of coarsening.

FIG. 2C is an illustration of the fine displacement field determination according to one embodiment. The coarsened displacement field

$${u}_{1}^{A C}$$

is determined once the first and second elements of

$${u}_{1}^{A}$$

are coarsened. The change in the displacement field corresponding to the new element group is illustrated as

$$Δ {u}_{2}^{A} .$$

The error E is the difference illustrated in FIG. 2B. The displacement field of the first and second group of elements can be determined as

$${u}_{2}^{A} = {u}_{1}^{A C} + Δ {u}_{2}^{A} .$$

The fine displacement field

$${u}_{2}^{00}$$

can be calculated as the sum of the coarsened displacement field

$${u}_{1}^{A C} ,$$

the change in displacement field at the present increment

$$Δ {u}_{2}^{A} ,$$

and the error E. The fine displacement field

$${u}_{2}^{00}$$

preserves the fine displacement associated with the first element and the second element.

As more elements are added to the adaptive mesh, the fine displacement field

$${u}_{i}^{00}$$

can be calculated for each addition. For example, when a third element group is added, the adaptive mesh having the second displacement field

$${u}_{2}^{A}$$

can be coarsened to an adaptive mesh having a coarsened displacement field

$${u}_{2}^{A C}$$

where the third and fourth elements are combined into a second coarsened element. The error E between

$${u}_{2}^{A} and {u}_{2}^{A C}$$

can represent a displacement of the third and fourth elements. The third displacement field

$${u}_{3}^{A}$$

can be calculated and the fine displacement field can be updated to generate

$${u}_{3}^{00}$$

representing the three element groups.

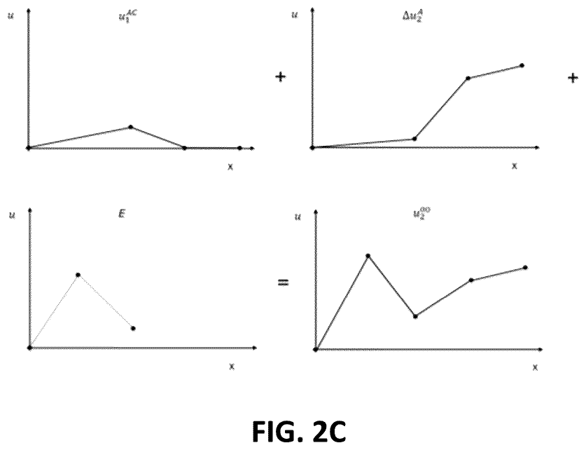

FIG. 3 is a flowchart of an adaptive mesh coarsening method, according to one embodiment. Initially, a non-homogenized FEA group of elements (e.g., voxels) can be added to an adaptive mesh (a first adaptive mesh) at step 310. As an initial condition,

$$i = 1 , {u}_{1}^{A} = 0 ,$$

and the error term E=0. At step 320, the adaptive mesh can be assessed to determine if any element groups meet the coarsening criterion. The coarsening criterion can be a pre-determined parameter that is based on the object being manufactured and/or the additive manufacturing process. In one embodiment, the coarsening criterion can be adaptive and can vary spatially or temporally throughout the additive manufacturing process.

When element groups do not meet the coarsening criterion, the method can proceed to step 350, wherein a second adaptive mesh is assembled to determine the displacement field

$${u}_{i}^{A}$$

with the new element group. When element groups do meet the coarsening criterion, the eligible elements can be coarsened in step 330 to determine the displacement field

$${u}_{i - 1}^{AC}$$

of the coarsened adaptive mesh. At step 340, the error E can be determined based on the difference between the displacement fields of the coarsened adaptive mesh

$${u}_{i - 1}^{AC}$$

and the adaptive mesh

$${u}_{i - 1}^{A} .$$

At set 350, the displacement field

$${u}_{i}^{A}$$

of the second adaptive mesh with the new element groups and coarsened elements can be determined. At step 360, the fine displacement

$${u}_{i}^{00}$$

field for the iteration can be determined based on the error E and the displacement field

$${u}_{i}^{A} .$$

At step 370, the adaptive mesh can be assessed to determine if all element groups have been added. When all the element groups have not been added, the method can repeat from step 310. When the mesh is completed, the method can terminate at step 380.

The determined fine displacement field

$${u}_{i}^{00}$$

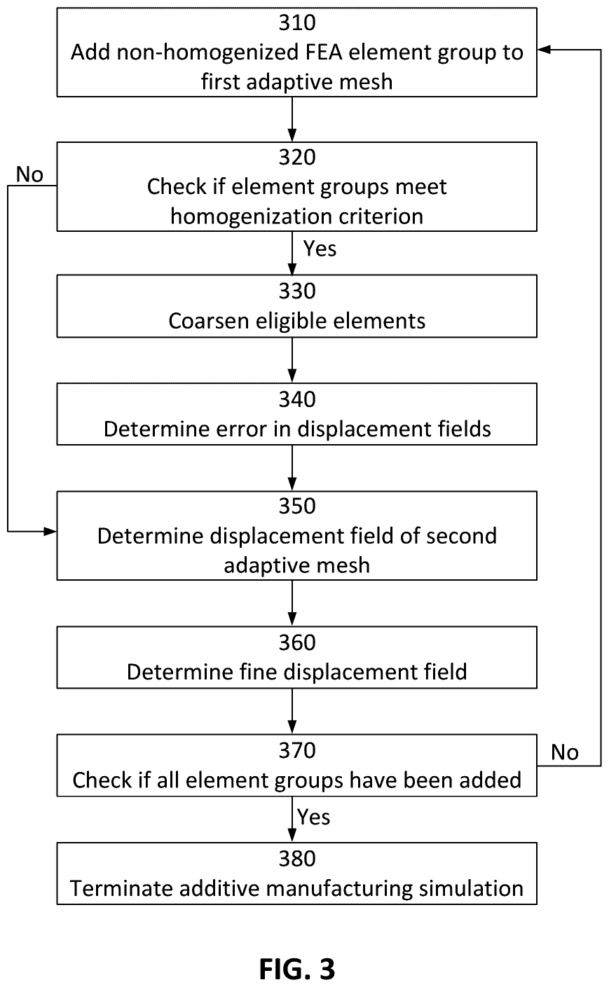

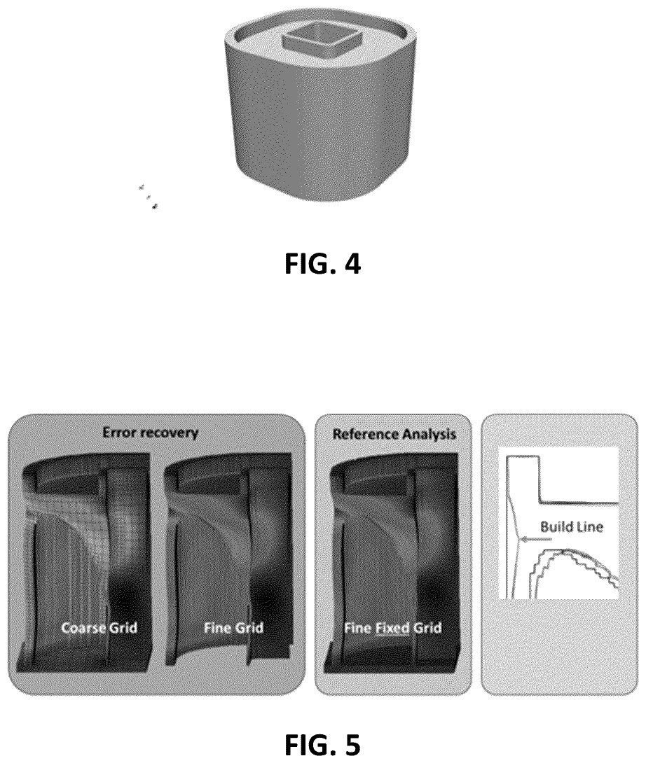

can be used to simulate the build process. For example, FIG. 4 illustrates a 32 millimeter (mm) by 32 mm by 25.4 mm object. The object can be fabricated using additive manufacturing. The object can be characterized by simulating application of plastic strain to a mesh model of the object in a single elastic time step. FIG. 5 illustrates predicted distortion of the object of FIG. 4 using different meshes for strain simulation. The simulation can be performed with a standard fine, fixed (not adaptive) mesh for reference analysis and a fine mesh that is generated using an adaptive mesh with error recovery. In one embodiment, the mesh elements can be hex-8 elements. In one embodiment, coarsening of the adaptive mesh can follow an octree scheme wherein a region is recursively subdivided into octants as elements.

Simulation using the error recovery method can be validated by comparing the predicted distortions of the adaptive mesh and the fine fixed mesh. The fine mesh that is generated using error recovery can be used to accurately predict distortion of the object, as illustrated in the profiles of FIG. 5. The method of error recovery presented herein enables accurate simulation of AM processes with aggressive application of mesh adaptivity to improve the efficiency of the simulation. The fine mesh that is generated using the adaptive mesh and error recovery maintains the resolution of the finest basis function, which can be used to accurately determine thermomechanical properties and/or material properties at a fine scale.

The fine mesh generated using the adaptive mesh and error recovery can be used for a variety of simulations and analyses. Further details about the mechanical simulation of the AM build process based on the meshes described herein can be found in Dong, Wen, et al. “A new procedure for implementing the modified inherent strain method with improved accuracy in predicting both residual stress and deformation for laser powder bed fusion,” Additive Manufacturing 47 (2021): 102345; Lindgren, Lars-Erik, and Andreas Lundbäck; “Approaches in computational welding mechanics applied to additive manufacturing: Review and outlook,” Comptes Rendus. Mécanique canique 346.11 (2018): 1033-1042; Chen, Qian, et al. “An inherent strain based multiscale modeling framework for simulating part-scale residual deformation for direct metal laser sintering,” Additive Manufacturing 28 (2019): 406-418; Bayat, Mohamad, et al. “A review of multi-scale and multi-physics simulations of metal additive manufacturing processes with focus on modeling strategies,” Additive Manufacturing 47 (2021): 102278; and Gouge, Michael, et al. “Experimental validation of thermo-mechanical part-scale modeling for laser powder bed fusion processes,” Additive Manufacturing 29 (2019): 100771, each of which is incorporated herein by reference in its entirety for all purposes.

The adaptive fine mesh described herein can be used for an additive manufacturing build. For example, an adaptive fine mesh can be used to simulate the process of fabricating an object using additive manufacturing. The simulation can identify issues in the additive manufacturing process, and the object and/or the additive manufacturing process can be modified in order to prevent said issues in a real build. In one example, the geometry of the object can be modified based on the adaptive fine mesh to improve the strength of the object. In one example, supports or scaffolds can be added to the object based on the adaptive fine mesh in order to stabilize the object during the additive manufacturing process. The modifications can be incorporated into an updated model (e.g., mesh) of the object.

In one embodiment, the method of FIG. 3 can further include fabricating the object using an additive manufacturing process based on the adaptive fine mesh generated in steps 310-370. In one embodiment, a manufacturing mesh can be generated based on the homogenized mesh. The manufacturing mesh can be an input to an additive manufacturing device to control the fabrication process. For example, the manufacturing mesh can be part of a design file such as an STL file that is used to program an additive manufacturing device. In one example, a laser can be used for additive manufacturing of metal objects. The additive manufacturing device can be, for example, a laser powder bed fusion (L-PBF) device, a direct metal laser sintering (DMLS) device, a selective laser melting (SLM) device, etc. The additive manufacturing device can include a laser that is configured to move across layers of metal material in order to fabricate the object. The movement of the laser beam can follow a path or pattern that is based on the manufacturing mesh. In one embodiment, the manufacturing mesh can be the adaptive fine mesh. In one embodiment, the manufacturing mesh can be a fixed mesh version of the homogenized mesh. The manufacturing mesh can be generated and/or updated according to the simulation of the adaptive fine mesh. The manufacturing mesh can be used to fabricate an object that will have the material properties that are determined by simulation using the adaptive fine mesh.

Examples of compatible additive manufacturing processes that can be performed based on or using the adaptive fine mesh of the present disclosure can be found in Tebianian, et al. “A review of the metal additive manufacturing processes,” Materials 16(24) (2023):7614.

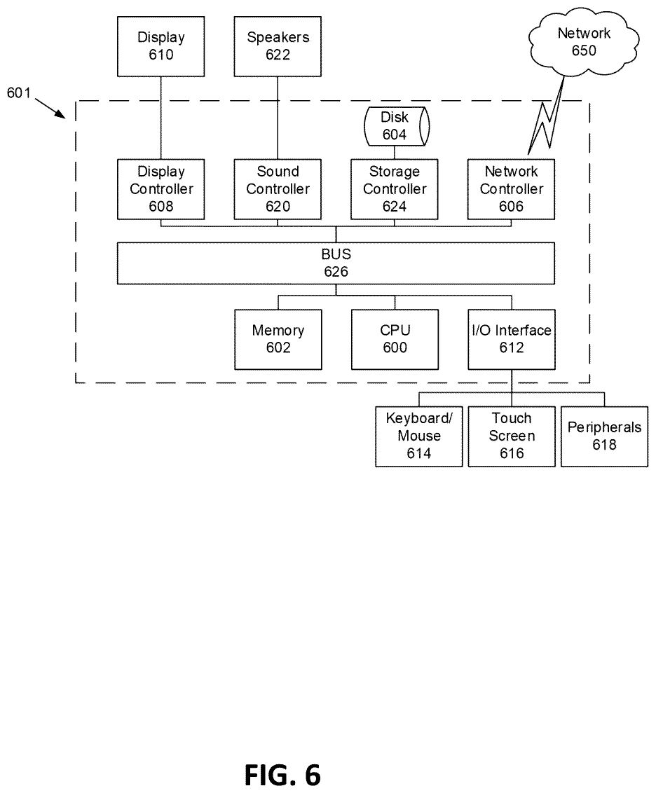

Next, a hardware description of a device 601 according to embodiments is described with reference to FIG. 6. In FIG. 6 the device 601 includes processing circuitry. The device 601 can be used to execute any of the methods described herein related to simulating or controlling additive manufacturing, applying adaptive meshing, coarsening elements in a mesh, performing FEA, determining material properties of an object, etc. In one embodiment, the device 601 can be a server, a computer, etc. In one embodiment, the device 601 can be in communication with or embedded in an additive manufacturing device, such as an AM printer. The device 601 can receive user input regarding coarsening parameters, such as a minimum or maximum voxel size, coarsening criteria, coarsening method, etc. In one embodiment, the methods described herein can be distributed across one or more devices, the one or more devices including at least some of the elements of device 601. The processing circuitry includes one or more of the elements discussed next with reference to FIG. 6. The process data and instructions for performing the methods described herein may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device 601 communicates, such as a server or computer.

Further, the claimed advancements may be provided as a utility application, background daemon, or component of an operating system, or combination thereof, executing in conjunction with CPU 600 and an operating system such as Microsoft Windows, UNIX, Solaris, LINUX, Apple MAC-OS and other systems known to those skilled in the art.

The hardware elements in order to achieve the device 601 may be realized by various circuitry elements, known to those skilled in the art. For example, CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the processes described above.

The device 601 in FIG. 6 also includes a network controller 606, such as an Intel Ethernet PRO network interface card from Intel Corporation of America, for interfacing with network 650. and to communicate with the other devices. As can be appreciated, the network 650 can be a public network, such as the Internet, or a private network such as an LAN or WAN network, or any combination thereof and can also include PSTN or ISDN sub-networks. The network 650 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device 601 further includes a display controller 608, such as a NVIDIA GeForce GTX or Quadro graphics adaptor from NVIDIA Corporation of America for interfacing with display 610, such as an LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners. A sound controller 620 is also provided in the device 601 to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the device 601. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

While this specification contains many specific implementation details, these should not be construed as limitations on the scope of what may be claimed, but rather as descriptions of features that may be specific to particular embodiments.

Certain features that are described in this specification in the context of separate

embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Embodiments of the present disclosure may also be set forth in the following parentheticals.

(1) A method of simulating additive manufacturing, the method comprising: determining a first displacement field on a first adaptive finite element mesh of an object; determining a second adaptive finite element mesh by adding an additional element group to the first adaptive finite element mesh, and when coarsening criteria is met, generating at least one coarse element by coarsening two or more elements of the first adaptive finite element mesh; calculating, from the first displacement field, a second displacement field on the determined second adaptive finite element mesh; determining an error between the first and second displacement fields; calculating a displacement field change on the determined second adaptive finite element mesh using a finite-element analysis model; and calculating a fine displacement field on a fine finite element mesh by adding together the second displacement field, the determined error, and the calculated displacement field change.

(2) The method of (1), wherein the coarsening criteria is that the two or more elements are not part of the additional element group, and the two or more elements are neighboring and have a same size.

(3) The method of (1) to (2), further comprising: determining the error to be zero when the coarsening criteria is not met.

(4) The method of (1) to (3), further comprising storing the determined error in a memory.

(5) The method of (1) to (4), further comprising repeating, for a plurality of additional element groups, the steps of determining the second adaptive finite element mesh, calculating the second displacement field, determining the error, calculating the displacement field change, and calculating the fine displacement field.

(6) The method of (1) to (5), further comprising simulating an additive manufacturing build of the object based on the calculated fine displacement field.

(7) The method of (1) to (6), wherein determining the error includes determining a difference based on the at least one coarse element of the first adaptive finite mesh.

(8) An apparatus for simulating additive manufacturing, comprising processing circuitry configured to determine a first displacement field on a first adaptive finite element mesh of an object, determine a second adaptive finite element mesh by adding an additional element group to the first adaptive finite element mesh, and when coarsening criteria is met, generating at least one coarse element by coarsening two or more elements of the first adaptive finite element mesh, calculate, from the first displacement field, a second displacement field on the determined second adaptive finite element mesh, determine an error between the first and second displacement fields, calculate a displacement field change on the determined second adaptive finite element mesh using a finite-element analysis model, and calculate a fine displacement field on a fine finite element mesh by adding together the second displacement field, the determined error, and the calculated displacement field change.

(9) The apparatus of (8), wherein the coarsening criteria is that the two or more elements are not part of the additional element group, and the two or more elements are neighboring and have a same size.

(10) The apparatus of (8) to (9) wherein the processing circuitry is further configured to determine the error to be zero when the coarsening criteria is not met.

(11) The apparatus of (8) to (10), wherein the processing circuitry is further configured to store the determined error in a memory.

(12) The apparatus of (8) to (11), wherein the processing circuitry is further configured to simulate an additive manufacturing build of the object based on the calculated fine displacement field.

(13) The apparatus of (8) to (12), wherein the processing circuitry is configured to determine the error by determining a difference in displacement field based on the at least one coarse element of the first adaptive finite mesh.

(14) A non-transitory computer-readable storage medium for storing computer readable instructions that, when executed by a computer, cause the computer to perform a method, the method comprising determining a first displacement field on a first adaptive finite element mesh of an object; determining a second adaptive finite element mesh by adding an additional element group to the first adaptive finite element mesh, and when coarsening criteria is met, generating at least one coarse element by coarsening two or more elements of the first adaptive finite element mesh; calculating, from the first displacement field, a second displacement field on the determined second adaptive finite element mesh; determining an error between the first and second displacement fields; calculating a displacement field change on the determined second adaptive finite element mesh using a finite-element analysis model; and calculating a fine displacement field on a fine finite element mesh by adding together the second displacement field, the determined error, and the calculated displacement field change.

(15) The non-transitory computer-readable storage medium of (14), wherein the coarsening criteria is that the two or more elements are not part of the additional element group, and the two or more elements are neighboring and have a same size.

(16) The non-transitory computer-readable storage medium of (14) to (15), the method further comprising determining the error to be zero when the coarsening criteria is not met.

(17) The non-transitory computer-readable storage medium of (14) to (16), the method further comprising storing the determined error in a memory.

(18) The non-transitory computer-readable storage medium of (14) to (17), the method further comprising repeating, for a plurality of additional element groups, the steps of determining the second adaptive finite element mesh, calculating the second displacement field, determining the error, calculating the displacement field change, and calculating the fine displacement field.

(19) The non-transitory computer-readable storage medium of (14) to (18), the method further comprising simulating an additive manufacturing build of the object based on the calculated fine displacement field.

(20) The non-transitory computer-readable storage medium of (14) to (19), wherein determining the error includes determining a difference based on the at least one coarse element of the first adaptive finite mesh.

Obviously, numerous modifications and variations of the present disclosure are possible in light of the above teachings. It is therefore to be understood that within the scope of the appended claims, the invention may be practiced otherwise than as specifically described herein.

1. A method of simulating additive manufacturing, the method comprising:
determining a first displacement field on a first adaptive finite element mesh of an object;
determining a second adaptive finite element mesh by adding an additional element group to the first adaptive finite element mesh, and when coarsening criteria is met, generating at least one coarse element by coarsening two or more elements of the first adaptive finite element mesh;
calculating, from the first displacement field, a second displacement field on the determined second adaptive finite element mesh;
determining an error between the first and second displacement fields;
calculating a displacement field change on the determined second adaptive finite element mesh using a finite-element analysis model; and
calculating a fine displacement field on a fine finite element mesh by adding together the second displacement field, the determined error, and the calculated displacement field change.

2. The method of claim 1, wherein the coarsening criteria is that (1) the two or more elements are not part of the additional element group, and (2) the two or more elements are neighboring and have a same size.

3. The method of claim 1, further comprising:
determining the error to be zero when the coarsening criteria is not met.

4. The method of claim 1, further comprising storing the determined error in a memory.

5. The method of claim 1, further comprising repeating, for a plurality of additional element groups, the steps of determining the second adaptive finite element mesh, calculating the second displacement field, determining the error, calculating the displacement field change, and calculating the fine displacement field.

6. The method of claim 1, further comprising simulating an additive manufacturing build of the object based on the calculated fine displacement field.

7. The method of claim 1, wherein determining the error includes determining a difference based on the at least one coarse element of the first adaptive finite mesh.

8. An apparatus for simulating additive manufacturing, comprising:
processing circuitry configured to
determine a first displacement field on a first adaptive finite element mesh of an object,
determine a second adaptive finite element mesh by adding an additional element group to the first adaptive finite element mesh, and when coarsening criteria is met, generating at least one coarse element by coarsening two or more elements of the first adaptive finite element mesh,
calculate, from the first displacement field, a second displacement field on the determined second adaptive finite element mesh,
determine an error between the first and second displacement fields,
calculate a displacement field change on the determined second adaptive finite element mesh using a finite-element analysis model, and
calculate a fine displacement field on a fine finite element mesh by adding together the second displacement field, the determined error, and the calculated displacement field change.

9. The apparatus of claim 8, wherein the processing circuitry is further configured to determine whether the coarsening criteria is met, wherein the coarsening criteria is that (1) the two or more elements are not part of the additional element group, and (2) the two or more elements are neighboring and have a same size.

10. The apparatus of claim 8, wherein the processing circuitry is further configured to determine the error to be zero when the coarsening criteria is not met.

11. The apparatus of claim 8, wherein the processing circuitry is further configured to store the determined error in a memory.

12. The apparatus of claim 8, wherein the processing circuitry is further configured to simulate an additive manufacturing build of the object based on the calculated fine displacement field.

13. The apparatus of claim 8, wherein the processing circuitry is further configured to determine the error by determining a difference in displacement field based on the at least one coarse element of the first adaptive finite mesh.

14. A non-transitory computer-readable storage medium for storing computer readable instructions that, when executed by a computer, cause the computer to perform a method, the method comprising:
determining a first displacement field on a first adaptive finite element mesh of an object;
determining a second adaptive finite element mesh by adding an additional element group to the first adaptive finite element mesh, and when coarsening criteria is met, generating at least one coarse element by coarsening two or more elements of the first adaptive finite element mesh;
calculating, from the first displacement field, a second displacement field on the determined second adaptive finite element mesh;
determining an error between the first and second displacement fields;
calculating a displacement field change on the determined second adaptive finite element mesh using a finite-element analysis model; and
calculating a fine displacement field on a fine finite element mesh by adding together the second displacement field, the determined error, and the calculated displacement field change.

15. The non-transitory computer-readable storage medium of claim 14, wherein the coarsening criteria is that (1) the two or more elements are not part of the additional element group, and (2) the two or more elements are neighboring and have a same size.

16. The non-transitory computer-readable storage medium of claim 14, the method further comprising:
determining the error to be zero when the coarsening criteria is not met.

17. The non-transitory computer-readable storage medium of claim 14, the method further comprising storing the determined error in a memory.

18. The non-transitory computer-readable storage medium of claim 14, the method further comprising repeating, for a plurality of additional element groups, the steps of determining the second adaptive finite element mesh, calculating the second displacement field, determining the error, calculating the displacement field change, and calculating the fine displacement field.

19. The non-transitory computer-readable storage medium of claim 14, the method further comprising simulating an additive manufacturing build of the object based on the calculated fine displacement field.

20. The non-transitory computer-readable storage medium of claim 14, wherein determining the error includes determining a difference based on the at least one coarse element of the first adaptive finite mesh.
